(19) United States
(12) Patent Application Publication
(10) Pub. No.: US 2008/0014330 A1
(43) Pub. Date: Jan. 17, 2008

(54) Vegetarian meat and manufacturing method thereof

(75) Inventors: Wen-Lian Chen, Hsinchu City (TW); Sam-Long Hwang, Hsinchu City (TW); Dong-Sheng Shiao, Hsinchu City (TW); Chian-Yuan Tsai, Hsinchu City (TW)

Correspondence Address: BIRCH STEWART KOLASCH & BIRCH, PO BOX 747, FALLS CHURCH, VA, 22040-0747, US

(73) Assignee: Food Industry Research & Development Institute

(21) Appl. No.: 11/598,810

(22) Filed: Nov. 14, 2006

(30) Foreign Application Priority Data
Jul. 12, 2006 (TW) 95125462

(51) Int. Cl. A23J 1/00

(52) U.S. Cl. 426/656

(57) ABSTRACT

A vegetarian meat and manufacturing method thereof. Whole soybeans are soaked, cooked and coagulated. After removal of whey, soybean curds having approximately 70% moisture content are formed. After mixing and extrusion, a vegetarian meat having high moisture content, texturization and nutrition is obtained.

### BACKGROUND OF THE INVENTION

1. Field of the Invention

The present invention relates to vegetarian meat, and in particular to a method for manufacturing soybean based vegetarian meat.

2. Description of the Related Art

The food industry has expended tremendous effort and resources in an attempt to utilize non-meat proteins, such as those derived from soybean or soybean protein, as additives to or substitutes for animal meat products. It long has been recognized that the ever-increasing worldwide food shortage could be in material part obviated if only such relatively inexpensive materials could be converted into products so closely approximating the naturally occurring food material that public acceptance would be achieved. One of the major roadblocks encountered by the industry has been the inability to impart the natural and accustomed chewy, fibrous texture to vegetable protein materials. Animal meat products inherently possess a texture giving them a definite “mouthfeel” which is clearly recognized and strongly preferred. Vegetable proteins in their natural state generally take the form of amorphous powders, which, despite their unquestioned nutritive value, possess mouthfeel characteristics wholly unacceptable to the consumer as a meat substitute. Moreover, vegetable proteins normally are characterized by objectionable “beany” flavors which the industry has been unable to remove or mask.

A variety of procedures have been developed for producing soybean vegetarian meat products from soy protein materials such as soybean meal, defatted soybean meal, and soy protein isolates and concentrates. Such procedures typically produce soybean vegetarian meat products by methods which involve either the manufacture of protein fibers or the thermoplastic extrusion of soy protein materials. In the manufacture of simulated meat products by protein fiber production, individual filaments or fibers are formed from the soy material, and the fibers are assembled into bundles to which binding agents, coloring and flavor are added. The fiber bundles are ultimately shaped to resemble familiar meat products.

The extrusion method of forming soybean vegetarian meat products from soy protein materials involves subjecting a mixture of soy protein material and water to heat and extrusion in an extruder to form a thermoplastic mass, and extruding the mass into cooling die for cooling and reducing to form a texturized structure. Extrusion procedures for producing soybean vegetarian meat are disclosed in U.S. Pat. Nos. 3,488,770, 3,911,159, 4,245,552, 4,128,051, 3,935,319, 4,057,656, C.A Pat No. 1059817, G.B Pat No. 1454736 and Taiwan Pat Nos. 133321, 339263.

These conventional procedures suffer from a number of disadvantages, which have restricted their widespread acceptability. For example, the cost of the soybean protein extraction and purification is expensive.

In the invention, whole soybean is used as a starting material to decrease the high cost of the conventional method, and the vegetarian meat is processed to form vegetarian hams or vegetarian steak. Additionally, mixing, flavoring and different cooling die are used to form the vegetarian product, such as vegetarian meat and hams. The invention does not require the steps of hydration, mixing, adding binder to improve adhesion.

### BRIEF SUMMARY OF INVENTION

The invention provides a vegetarian meat having high moisture content, texturization and nutrition. An exemplary embodiment of a method for manufacturing vegetarian meat comprises: utilizing whole soybeans and producing soybean curds, mixing the soybean curds and a ingredient to form a mixture; extruding the mixture to form a food fluid; heating the food fluid at different temperatures; and extruding the food fluid into cooling die to form a vegetarian meat.

The soybean vegetarian meat has a moisture content of 40-70%, and the tear strength of fiber is 400-1100 g/cm².

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a flow chart of showing the steps for manufacturing soybean vegetarian meat according to a preferred embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

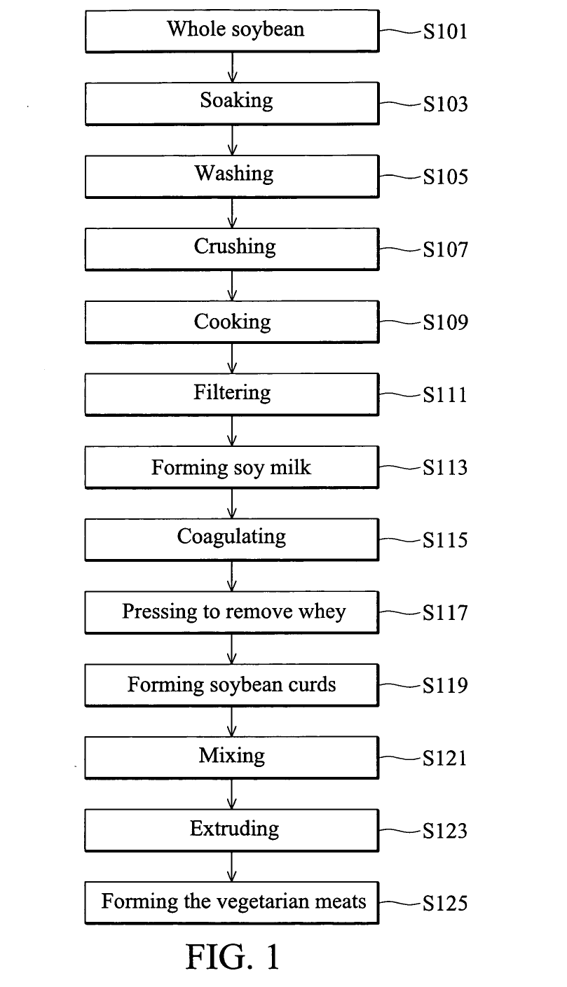

FIG. 1 shows a flow chart of showing the steps for manufacturing soybean vegetarian meat according to a preferred embodiment of the invention.

Referring to FIG. 1, in S101, compared to conventional process, whole soybean is used as a starting material. Referring to step S103, whole soybeans are washed and soaked about 5 to 8 hours. Referring to steps 105 and S107, after soaking, the soybeans are washed with water, crushed to form the soybean slurry. A typical crushing is a grinder. The amount of water percentage during the grinding or crushing step is preferably about 10 to about 15 times the dry weight of the soybeans. The grinding or crushing can be carried out at room temperature, but preferably is carried out in injection steam to about 80 to 95° C. The utilized temperature helps deactivate lipoxidase during the grinding or crushing step. The grinding or crushing step yields soybean slurry having a weight ratio of soybeans to water of about 1:15, more preferably about 1:10.

Referring to step S109, soybean slurry is cooked at about 100 to 110° C. for about 2 to 6 minutes. The soybean slurry is cooked in a steam kettle, heat exchanger, steam injected cooker, or other suitable cooker. The cooking step should be performed soon after grinding or crushing, preferably less than 5 minutes. Referring to steps S111 and S113, after cooking, the soybean slurry is filtered to yield soy milk. Filtering is performed by a roller or vibrate mesh.

Referring to step S115, coagulants are added to the soybean milk. The soy milk is normally at 80 to 90° C. at this point, and is then coagulated by addition of a coagulant. It should be noted that curds do not form below about 50° C., whereas curds formed at above 95° C., are too soft. The soy milk has a pH of 5.9 to 6.3. The pH of soy milk can be adjusted by sodium carbonate or sodium hydroxide if necessary, so that it is within the above ranges. A divalent metal salt of well known coagulants can be used such as calcium chloride, magnesium chloride, magnesium sulfate and calcium sulfate. Other coagulant also can be used such as glucono delta lactone (GDL). A preferred coagulant is GDL. The weight ratio of GDL to soy milk is about 0.2% to 0.6%, more preferably between about 0.3% and 0.4%.

Referring to steps S117 and S119, soy whey is removed to could obtain soy curd. The curds are pressed to remove supernatant liquid by a filter. For example, at about 0.05 to about 0.2 psi for about 15-20 minutes. The soybean curd is similar to tofu, having 40% to 70% moisture content, more preferably 70%.

Referring to step S121, the soybean curds are mixed with at least one of wheat starch, soybean flour and sodium bicarbonate to form a mixture. The ratio of soybean curds, wheat starch, soybean flour and sodium bicarbonate is about 100-120:10-20:40-50:1-10, more preferably about 100-110:10-15:40-45:2-8.

Referring to step S123, the water feeded into extruder are extrusion to form a food fluid. In one embodiment, food fluid has a moisture content of 40%-70%, more preferably 50%-60%. In the extruder, the flow rate of food fluid is between 20 kg/hr to 35 kg/hr, more preferably 25 kg/hr to 30 kg/hr. Additionally, the food fluid is heated during the extrusion step by a barrel of the extruder. The barrel has at least 3, preferably, six heating regions, wherein the fourth and fifth heating regions are hotter than second and third heating regions. The temperature of the first region is at about 10-30° C., more preferably about 15-25° C. The second to sixth regions of the stepwise heating are carried out at 90-110° C., 90-115° C., 145-165° C., 140-165° C., and 100-140° C., respectively, more preferably about 90-100° C., 90-110° C., 150-160° C., 150-165° C., and 115-125° C. The screw of the extruder provides the force of the moving, pressing, mixing, kneading and shearing. The rotation speed of the screw is at about 120 to 160 rpm, more preferably about 130 to 150 rpm. Additionally, the barrel provides the enough enthalpy for cooking, sterilizing, deactivate enzyme and texturizing during the extrusion.

Referring to step S125, finally, the food fluid is molded and cooled to form the soybean vegetarian meat with a cooling die of the invention. The cooling die is includes a first and a second half part, which form a die space when combined. The cooling die space comprises an inlet and a manifold connected thereto. The food fluid enters the cooling die from inlet. The manifold expands to form a flat, with an angle ranging from 45 to 90 degrees. Additionally, the cooling die includes 4 length (4 parts). Suitable cooling die includes round, square or flat, wherein the flat die is particularly preferred. The die is carried out at temperature between 90 and 140° C., more preferably about 100 to 130° C. The die is carried out at pressure between 1 and 15 kg/cm², more preferably about 2 to 10 kg/cm².

In the preferred embodiment of the invention, whole soybean in used as a starting material, instead of soybean protein isolate. The soybean vegetarian meat of the invention features high moisture content, texturization and nutrition, wherein the moisture content between about 40% and 70%, and the fiber tear strength between 400-1100 g/cm². The soybean vegetarian meat of the invention near animal meat.

### EXAMPLE 1

Whole soybeans were soaked, ground, cooked and filtered to obtain soy milk. GDL was added to soy milk at 80° C. having ratio of GDL to soy milk of 0.2% to 0.5%. After removing the whey, the soybean curds were formed. The soybean curds, wheat starch, soybean flour, sodium bicarbonate were mixed. The ratio of soybean curds, wheat starch, soybean flour and sodium bicarbonate was 100%: 11%: 43%: 5%. The mixture and water was feeded and cooked in the extruder by feeder and water pump. At the time of extrusion, the moisture content of the food fluid was 50-70%. In the extruder, the flow rate of food fluid was between 25 and 35 kg/hr, and second to sixth regions of the stepwise heating were carried out at 90° C., 110° C., 165° C., 160° C., and 120° C. respectively. A 4 parts flat cooling die was used (the size of the upper cover is 149×105×26 mm (length, wide, height), the size of the base is 149×105×34 mm, the size of the central protrusion of the upper cover is 149×50×2 mm, the size of the central recess of the base is 149×50×5 mm. The combination of upper cover and base forms a food fluid space, and its size is 149×50×3 mm). The die was carried out at temperature between 100-130° C. and cooled to 85-95° C. by circulating water. The die was carried out at pressure between 2 to 10 kg/cm². The soybean vegetarian meat of the invention comprise high moisture content, texturization and nutrition, wherein the moisture content was between about 40%-70%, and the fiber tear strength was between 400-1100 g/cm².

### EXAMPLE 2

The same procedure carried out in Example 1 was repeated except that the ratio of the soybean curds to wheat starch was changed to 70%: 30%, and the pH value was adjusted to 7-8 by sodium carbonate or sodium hydroxide. At the same time, soya sauce, sugar, salt, monosodium glutamate, color and flavor (see Table 1) was added into the source. In the extruder, moisture content was between 40% and 70%, the rate of food fluid was between about 30 and 35 kg/hr, the rate of the screw was at 160 rpm, and second to sixth parts of the stepwise heating are carried out at 90° C., 100° C., 130° C., 150° C., and 145° C. respectively. A 4 parts flat cooling die was used (the size of upper cover is 150×150×26 mm (length, wide, height), the size of central protrusion of the upper cover is 150×100×2 mm, the base is 150×150×40 mm, the size of the central recess is 150×100×12 mm. The combination of upper cover and base to form a food fluid space of the cooling die, the space of food fluid is formed, and its size is 150×100×10 mm). The die is carried out at temperature between 130-140° C., and the die is carried out at pressure about 1-4 kg/cm².

TABLE 1

| Additive | Ratio (%) |
|---|---|
| Sugar | 3.5 |
| Salt | 1.0 |
| monosodium glutamate | 0.3 |
| the flavor of vegetarian meat | 0.2 |
| soya source | 5.0 |
| Monascus pigment | 0.2 |

The soybean vegetarian meat of the invention comprises high moisture content, texturization and nutrition, wherein the moisture content was between about 60%-65%, and the fiber tear strength was between 3500-6500 g/cm². Although a flat cooling die was used in the above examples, it should be noted that different soybean vegetarian meats could be produced via various cooling die. For example, round cooling die can be used to make vegetarian hams, a flat cooling die can be used to make vegetarian steak, and a square cooling die can be used to make vegetarian meat strips.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for producing a vegetarian meat, comprising
processing whole soybean into a soybean curd;
mixing the soybean curd and a ingredient to form a mixture;
extrusion the mixture to form a food fluid;
stepwise heating the food fluid at different temperatures; and
extrusion the food fluid with a cooling die to form a vegetarian meat.

2. The method for producing a vegetarian meat as claimed in claim 1, wherein the vegetarian meat has a moisture content of about 40-70%.

3. The method for producing a vegetarian meat as claimed in claim 1, wherein the ingredient comprises wheat starch, soybean flour, sodium bicarbonate combinations thereof.

4. The method for producing a vegetarian meat as claimed in claim 1, wherein the food fluid has a moisture content of about 40-70%.

5. The method for producing a vegetarian meat as claimed in claim 1, wherein the stepwise heating comprises at least three parts.

6. The method for producing a vegetarian meat as claimed in claim 1, wherein the heating comprises six parts.

7. The method for producing a vegetarian meat as claimed in claim 6, wherein second to sixth parts of the stepwise heating are carried out at 90-100° C., 90-110° C., 150-165° C. and 115-125° C., respectively.

8. The method for producing a vegetarian meat as claimed in claim 1, wherein the molding is carried out using a cooling die.

9. The method for producing a vegetarian meat as claimed in claim 8, wherein the cooling die is carried out at temperature about 100 and 130° C.

10. The method for vegetarian meat as claimed in claim 8, wherein the cooling die is carried out at pressure between 2 and 10 kg/cm².

11. A vegetarian meat prepared by the method of claim 1, wherein the vegetarian meat has a moisture content of 40-70%.
